(19) United States
(12) Patent Application Publication
(10) Pub. No.: US 2011/0045728 A1
(43) Pub. Date: Feb. 24, 2011

(54) Fiber Blends, Yarns And Fabrics Made Thereof

(75) Inventors: Friedrich Weninger, Mondee (AT); Dieter Eichinger, Furstenfeld (AT); Whilhelm Feilmair, Seewalchen (AT); Johann Leitner, Haid (AT); Karin Kämpf, Eberschwang (AT)

Correspondence Address: FITZPATRICK CELLA HARPER & SCINTO, 1290 Avenue of the Americas, NEW YORK, NY, 10104-3800, US

(73) Assignee: Lenzing AG, Lenzing (AT)

(21) Appl. No.: 12/812,798

(22) PCT Filed: Dec. 22, 2008
(86) PCT No.: PCT/AT2008/000468

§ 371 Date: Jul. 14, 2010

(30) Foreign Application Priority Data
Jan. 16, 2008 (AT) A64/2008

(51) Int. Cl. C08B 15/10; C09K 3/00; B32B 5/02

(52) U.S. Cl. 442/304; 536/56; 252/182.12; 428/221

(57) ABSTRACT

The invention relates to blends of high wet modulus cellulosic fibers and solvent spun cellulosic fibers and yarns and fabrics made thereof.

### BACKGROUND OF THE INVENTION

1. Field of the Invention

This invention relates to blends of high wet modulus cellulosic fibers and solvent spun cellulosic fibers and yarns and fabrics made thereof.

2. Description of Related Art

High wet modulus cellulosic fibers based on viscose technology are state of the art and are well described in literature. One possible process for their manufacture is described in U.S. Pat. No. 3,539,678. The high wet modulus cellulosic fibers according to the present invention shall be fibers manufactured according to such a viscose technology-based process and exhibiting a strength (Bc) in conditioned state of Bc(cN)≧1.3√T+2T and a wet modulus (Bm) at an elongation of 5% in wet state of Bc(cN)≧0.5*√T, T being defined as the single fiber denier in the unit “dtex”. All units and properties are as defined by the BISFA (INTERNATIONAL BUREAU FOR THE STANDARDISATION OF MAN-MADE FIBERS).

A newer type of cellulosic fibers are solvent-spun cellulosic fibers. One of the possible solvents used in their manufacturing process consists mainly of an aminoxide and water. This process is also well known and described in literature. Other possible solvents for the production of solvent-spun cellulosic fibers are so-called “ionic liquids”. These solvents are described, e.g., in WO 03/029329 and WO 06/108861.

These solvent-spun cellulosic fibers have higher dry and wet tenacities compared to other cellulosic fibers and exhibit a certain property called fibrillation. The fibrillation tendency of a single fiber can be measured e.g. by the NSF method (wet abrasion value), described in WO 99/19555. For a variety of applications this fibrillation is advantageous. For other applications the fibrillation is undesirable. Typically high wet modulus cellulosic fibers and solvent-spun cellulosic fibers are used in textile industry as 100% yarns but also in blends with polyester and other synthetic fibers. In these blends the cellulosic fibers are advantageous because of their humidity management abilities. This leads to an enhanced wear comfort. Typically high wet modulus cellulosic fibers and solvent-spun cellulosic fibers are also used in blends with cotton.

Around the year 2000 there was created a special fiber blend of high wet modulus cellulosic fibers and solvent-spun cellulosic fibers. The typical blend ratio for fibrillating solvent-spun cellulosic fibers with an NSF value of about 50 was 30%. One of the typical advantages of that fiber blend was the contribution of the high wet and dry fiber tenacity of solvent-spun cellulosic fibers to the fiber blend and the resulting yarns. This gave advantages in processing the yarns to fabrics (mainly weaving) and resulted in improved fabric properties like decreased wash shrinking which are in close relation to high wet and dry tenacity.

Furthermore a special fiber blend was created by mixing high wet modulus cellulosic fibers and fibrillating solvent-spun cellulosic fibers. Unfortunately this blend did not exhibit significant advantages as high wet modulus cellulosic fiber itself has a significantly higher fiber tenacity as typical viscose fibers and especially high wet modulus cellulosic fibers outperform typical viscose fibers in respect to wet fiber tenacity and wet modulus. Typical values for wet modulus are 2.5 cN/tex for viscose fibers and 5.6 cN/tex for high wet modulus cellulosic fibers. This means that in the blend with Lenzing Viscose® the solvent-spun cellulosic fibers could bring in significant better product characteristics, whereas in the blend with high wet modulus cellulosic fibers the 30% share of the solvent-spun cellulosic fibers did not show up significant improvements.

Furthermore a very serious draw back occurred for processing of blends out of high wet modulus cellulosic fibers and fibrillating solvent-spun cellulosic fibers. It led to severe problems in knit applications and there especially gave tremendous problems during typical wet processing steps like dyeing and subsequently following household laundry. The appearance of the fabrics was disturbed by so called creasing and friction marks (bright lines and areas, caused by fibrillated solvent-spun cellulosic fibers).

The reason why knit products show up this negative fibrillation behavior is that knit products have a much more loose and open structure compared to woven fabrics and that typically resin finishing is not applied to knit products.

Moreover the pilling performance of those knits could not be improved. Pilling is the terminus for a certain fabric appearance. Pills are small fiber aggregates which can be formed during several washing and drying cycles. Too much pills deteriorate a proper fabric and garment appearance.

This all led to the conclusion that a blend of high wet modulus fibers and solvent-spun cellulosic fibers does not give any advantage. Instead it will be supposed that the addition of solvent-spun cellulosic fibers will diminish the properties compared to pure high wet modulus fibers.

In the meantime different treatments of the solvent-spun cellulosic fibers were developed to decrease their tendency to fibrillate. Most of these treatments include a chemical cross linking step in the never-dried state using different cross linking substances. Unfortunately crosslinking leads to a certain loss in fiber tenacity (wet and dry). Furthermore the cross linking chemicals show different sensitivity to acidic or alkaline conditions.

But there has to be distinguished between pilling and fibrillation. While fibrillation is a typical property of solvent-spun cellulosic fibers and only a few other cellulosic fibers like Polynosic and is caused by the individual microstructure formed through a certain spinning process, pilling can occur with almost every fiber, even with cotton and polyester. Therefore there is no clear correlation between the fibrillation tendency and the pilling tendency of a certain fiber type.

One of the targets of developing crosslinked solvent-spun cellulosic fibers was to obtain a fibrillation tendency similar to cotton, viscose or high wet modulus cellulosic fibers. As it was shown above, one would not expect that the pilling performance would be improved as well.

Another disadvantage of the fiber blends of this state of the art is their dye affinity relative to that of fibers they should be mixed with, especially cotton. The blends consisting of high wet modulus cellulosic fibers and fibrillating solvent-spun cellulosic fibers show a much higher dye uptake than cotton which leads to uneven dyeing results and decreased economy of the dyeing processes. Despite the fact that these blends with cotton show a much softer touch than pure cotton these disadvantages made a market success impossible.

In view of this state of the art the problem consisted in finding a material which shows both enhanced wear comfort and high dry and wet tenacity as well as a good abrasion resistance, low wash shrinkage, dyeability compatible to other fibers like cotton and a soft touch in a mixture with these other fibers. The high tenacity is especially useful if thin fabrics are needed in view of softer touch, lightweight needs, clothing suitable for summer or for tropical areas. Good abrasion resistance and low wash shrinkage contribute to easy-care properties which become more and more important to the customer.

### SUMMARY OF THE INVENTION

In view of the description above a blend of high wet modulus cellulosic fibers with non-fibrillating solvent-spun cellulosic fibers is not expected to give any significantly improved characteristics, especially in terms of pilling performance.

But surprisingly it was found that a fabric made of or containing a major portion of a blend of a high wet modulus cellulosic fiber and a solvent spun cellulosic fiber with an NSF value of more than 200 showed not only no decrease in pilling performance, compared to a fabric made of pure high wet modulus cellulosic fiber, and no fibrillation (as could of course be expected from a fiber with a high NSF value), but a significantly improved pilling performance. The pilling performance can be quantitatively evaluated by the “pilling-area” method.

For most applications the solvent spun cellulosic fiber with high NSF value is cross-linked with an alkali-resistant cross-linking agent, because the fiber blend according to the invention is preferably mixed with other cellulosic fibers and such fibers are commonly exposed to alkaline baths during dyeing. Therefore alkali-resistant cross-linking is preferred, but the acid-resistant cross-linked solvent spun cellulosic fibers in principal show the same advantages with respect to pilling performance and may be used especially for applications which require acidic steps during the aftertreatment.

Especially suitable is an alkali-resistant cross-linking agent of the following formula (I):

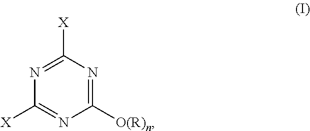

wherein X represents Halogen, R=H or an ionic residue and n=0 or 1, or a salt of this compound. In principle, this treatment is already known from WO 99/19555.

Even more surprisingly it was found that the dyeability of the solvent spun cellulosic fiber with an NSF value of more than 200 was compatible with that of cotton, which resulted in even dyeing results and increased dye-house economy.

Also suitable, especially for the case when mixtures with synthetic fibers, i.e. polyester are intended, is an acid-resistant cross-linking treatment which is already known from WO 94/09191. One preferred cross-linking agent in this embodiment of the invention is 1,3,5-triacryloylhexahydro-s-triazine (THAT).

Preferably the fabric is a knitted fabric.

### BRIEF DESCRIPTION OF THE DRAWINGS

For a more complete understanding of the present invention and the advantages thereof, reference is made to the following descriptions, taken in conjunction with the accompanying drawing, in which:

FIG. 1 is a graph comparing the pilling area after a number of washing cycles of 100% high wet modulus cellulosic fibers and an exemplary embodiment of the invention comprising a 50/50% mixture of high wet modulus cellulosic fibers and solvent-spun cellulosic fibers.

### DETAILED DESCRIPTION OF THE INVENTION

In one preferred embodiment of the invention the solvent spun cellulosic fiber are cross-linked in the never dried state. Solvent-spun fibers in their state before the first drying are designated as “never dried” fibers. It has been shown that the use of compounds of the formula (I) on never dried fibers in particular produces a considerable reduction in the tendency to fibrillate.

In a preferred embodiment of the invention the fabric contains between 30 and 100 weight-% of the blend of the high wet modulus cellulosic fiber and the cross-linked solvent spun cellulosic fiber. The remaining part may consist of another fiber. Preferred are other cellulosic fibers and most preferred is cotton. This other fiber can be mixed with the fiber blend according to the invention by mixing before the carding machine or by mixing card slivers or draw frame slivers.

Especially for the manufacture of underwear also Elastan or polyamide fibers may be used additionally.

In one preferred embodiment the fabric consists to 100% of the blend of the high wet modulus cellulosic fiber and the cross-linked solvent spun cellulosic fiber.

In a preferred embodiment of the invention the blend contains 5% to 80%, more preferably 20% to 70% and most preferably 30% to 50% of the cross-linked solvent spun cellulosic fiber.

Another subject of the present invention is a yarn consisting of or containing a blend of a high wet modulus cellulosic fiber and a solvent spun cellulosic fiber with an NSF value of more than 200. Beneath this blend the yarn may contain between 0 and 70% of an additional fiber. Preferred are other cellulosic fibers and most preferred is cotton. This other fiber can be mixed with the fiber blend according to the invention by mixing before the carding machine or by mixing card slivers or draw frame slivers. This yarn may be used to produce a knitted fabric. Said fabric may contain from 30 to 100% of said yarn.

In a preferred embodiment this yarn contains 5% to 80% of the solvent spun cellulosic fiber with an NSF value of more than 200; and even more preferably 20% to 70%; most preferably the yarn contains 30% to 50% of said solvent spun cellulosic fiber.

Because of their softness, easy-care properties and good body climate properties the yarns and fabrics according to the invention are especially suitable for the use in underwear.

The invention will now be illustrated by examples. These examples are not limiting the scope of the invention in any way.

Yarns were ring spun from pure high wet modulus cellulosic fibers and a 50%/50% blend (mixed in the loose stock) of high wet modulus cellulosic fibers/solvent-spun cellulosic fibers. The solvent-spun cellulosic fibers were made by the aminoxide process. All fibers were 1.3 dtex/38 mm. The non-fibrillating solvent-spun cellulosic fibers were crosslinked according to WO 99/19555 and showed an NSF value of 590.

The yarn count was Nm 68/1 and the yarn twist was αm=105. The yarns were knitted to a single jersey with a weight of 105 g/m2. The knits were treated according to the following processing conditions on a Thies Mini-Softflow TRD dyeing machine. The washing was performed with 1 g/l Kieralon JET, 1 g/l sodium carbonate, 1 g/l Albegal FFA, 1 g/l Persoftal L for a time of 20 minutes at 80° C.; then the fabric was rinsed warm and cold. The reactive dyeing was performed with a liquor ratio=1:34, and a dye mixture of 0.50% Remazol Golden Yellow RNL 150%, 1.00% Remazol Red RB 133%, 0.75% Remazol Navy Blue RGB 150%. Additionally the lye contained 50 g/l sodium sulphate, 1 g/l Albegal FFA, 1 g/l Persoftal L. The fabric was treated 15 minutes at 25° C. Then 5 g/l sodium carbonate were added and the treatment was continued for additional 5 minutes. After that time the temperature was raised to 60° C. within 30 minutes and kept for additional 30 minutes. Then 0.5 ml/l caustic soda 38° Bé was added. After another 60 minutes at 60° C. the lye was removed.

The post-treatment contained the following sequence: rinse cold, acidify: 1 ml/l acetic acid 60% (10′/40° C.), rinse warm with soap: 1 g/l Kieralon JET (20′/90° C.); rinse warm and cold. Afterwards a softening step was applied with 2% Evo Soft VNI for a period of 20 minutes at 40° C.

The fabrics were then washed repeatedly according to ISO 6330 Program 2A and samples were taken after 1/5/10/15/20/25 washing cycles for the determination of the pilling area.

The pilled area was estimated by using a photo camera system and a picture analysing system for the counting of the pills per area. The photo camera system was equipped with a camera Olympus Color View III, a Schneider Kreuznach 1.7/23 lens and a 110 mm LED ring light LDR-146 LA of CCS Corp. The pictures were analyzed by an Olympus AnalySIS “auto” program on a standard personal computer. The knitted fabric must be positioned plain and without tension directly under and in contact with the ring light. The photo is taken with the camera in “Automatic” mode. The camera shall be mounted in a distance which results in a diagonal of 5 cm. The aperture shall be set to 2.8, the ring light to L4:13 and the detection area to 40×30 mm. For the analysis the mode for blue fabrics with a threshold value of (150-255) shall be used.

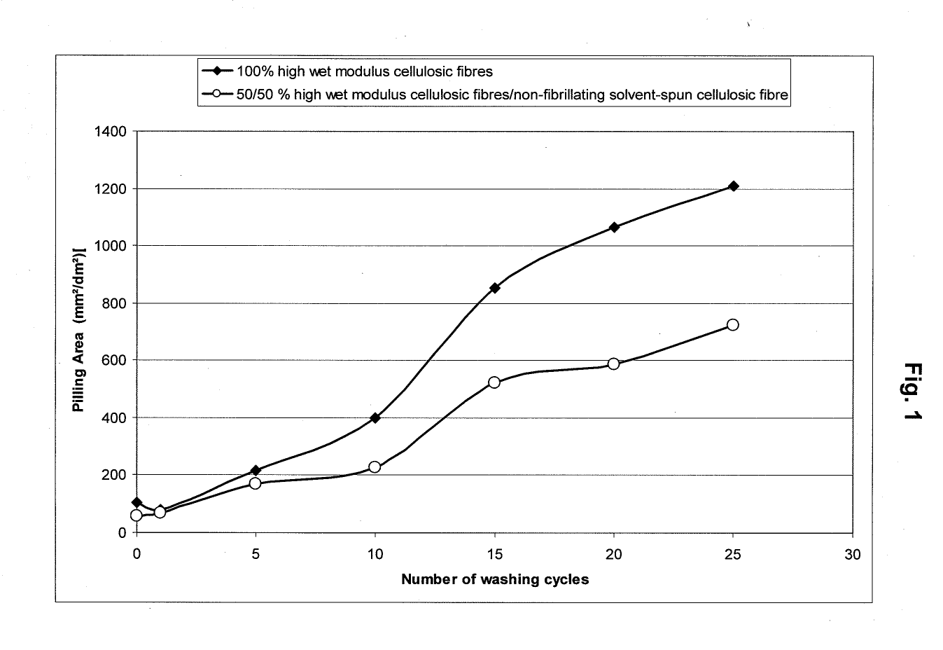

Enclosed are a table and a graph showing pilling performance versus washing cycles. A 100% high wet modulus cellulosic fiber fabric is compared with a 50%/50% blend of high wet modulus cellulosic fibers and non-fibrillating solvent spun cellulosic fiber. These data clearly show that the blend according to the invention exhibits a significantly reduced pilled area (FIG. 1).

TABLE 1

| | Pilling area [mm2/dm2] | | | | | | |
|---|---|---|---|---|---|---|---|
| Number of washing cycles | 0 | 1 | 5 | 10 | 15 | 20 | 25 |
| 100% high wet modulus | 103 | 81 | 217 | 400 | 852 | 1067 | 1208 |
| cellulosic fibers | | | | | | | |
| 50/50% high wet modulus | 59 | 69 | 167 | 225 | 523 | 587 | 722 |
| cellulosic fibers/non-fibrillating | | | | | | | |
| solvent-spun cellulosic fiber | | | | | | | |

What is claimed is:

1. A fiber blend comprising a high wet modulus cellulosic fiber and a solvent-spun cellulosic fiber, wherein the solvent spun cellulosic fiber exhibits an NSF-value of >200.

2. The fiber blend according to claim 1, wherein the solvent spun cellulosic fiber is cross-linked with a cross-linking agent.

3. The fiber blend according to claim 2, wherein the cross-linked solvent spun cellulosic fiber is cross-linked with an alkali-resistant cross-linking agent.

4. The fiber blend according to claim 2 or 3, wherein the cross-linked solvent spun cellulosic fiber is crosslinked in the never-dried state.

5. The fiber blend according to claim 1, wherein the fiber blend comprises from 5% to 80%, preferably 20% to 70% and more preferably 30% to 50% of the cross-linked solvent spun cellulosic fiber.

6. A yarn comprising from 30 to 100% of a fiber blend according to claim 1.

7. The yarn according to claim 6, wherein the yarn further comprises a third fiber species.

8. The yarn according to claim 7, wherein the third fiber species is cotton.

9. A fabric, containing from 30 to 100% of a fiber blend according to claim 1.

10. The fabric according to claim 9, wherein the fabric further comprises a third fiber species.

11. The fabric according to claim 10, wherein the third fiber species is cotton.

12. The fabric according to claim 9, 10 or 11, wherein the fabric is a knitted fabric.

13. A method of making a fabric comprising using the fiber blend according to claim 1.

14. A method of making a fabric comprising using the yarn according to claim 6.

15. The method according to claim 13 or 14, wherein the fabric is a knitted fabric.
